(19) United States
(12) Patent Application Publication
(10) Pub. No.: US 2013/0124985 A1
(43) Pub. Date: May 16, 2013

(54) Conditional Localization of Singular and Plural Words

(71) Applicants: Gaurav Rajkumar Doshi, Seattle, WA (US); Emre Bogazliyanlioglu, Kirkland, WA (US); Benoît Devigne, Dublin (IE); Federica Rogora, Churchtown (IE); Alfred Hellstern, Redmond, WA (US)

(72) Inventors: Gaurav Rajkumar Doshi, Seattle, WA (US); Emre Bogazliyanlioglu, Kirkland, WA (US); Benoît Devigne, Dublin (IE); Federica Rogora, Churchtown (IE); Alfred Hellstern, Redmond, WA (US)

(73) Assignee: Microsoft Corporation, Redmond, WA (US)

(21) Appl. No.: 13/293,480

(22) Filed: Nov. 10, 2011

(51) Int. Cl. G06F 17/24

(52) U.S. Cl. 715/256

(57) ABSTRACT

Conditional localization may be provided. A message comprising a numeric component may be prepared for display on a user interface. In response to determining that the numeric component is associated with a descriptor word, a localized variant of the descriptor word may be retrieved according to the numeric component.

### BACKGROUND

Conditional localization may be provided. In conventional systems, user interface strings are insensitive to the singular/plural nature of the terms to which they refer. For example, an error message that conveys a failed upload of documents will always be the same whether the user was trying to upload one document or multiple. To get around the issue of singular (“document”) and plural (“documents”), some systems display a “(s)” while others hardcode a count into every display message. These workarounds are inelegant and inefficient when messages are displayed in a single language, and such issues multiply when a product must be able to operate in numerous other languages.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Conditional localization may be provided. A message comprising a numeric component may be prepared for display on a user interface. In response to determining that the numeric component is associated with a descriptor word, a localized variant of the descriptor word may be retrieved according to the numeric component.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing conditional localization; and

FIG. 3 is a block diagram of a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention.

In order to provide localization for singular/plural variations of a word, a matrix of combinations may be stored in a resource file. Intervals may be stored in one localized text as a delimiter separated list of ‘number-number’ pairs. The first number generally may not be empty. The second number may be empty, which may indicate positive infinity. There may be overlaps between intervals, but generally there should not be any gaps. If there's any overlap, the first one matched may be used. Interval definitions may be in increasing order, but may not be required to be. The localized data for the intervals may be defined in a separate localized text. Each localized text may have one interval definition that may be a parallel array to the interval definitions where each definition may match the interval it'll be representing. It is possible for some languages to make use of common intervals for different localized texts.

Interval and localization variants may be stored in XML format in separate and/or single resource files and/or other memory storage sources. An example interval entry may comprise <value>0|1|2-</value>, indicating that variants for 0, 1, and 2 or greater are available. For the word “reply”, the matching localization variant entry may comprise <value>replies|reply|replies</value>. In this example, “|” is used as a delimiter but other characters may also be used. Some languages, such as Russian and Arabic, may have additional variants for different value ranges and/or may have variants for numbers in negative ranges.

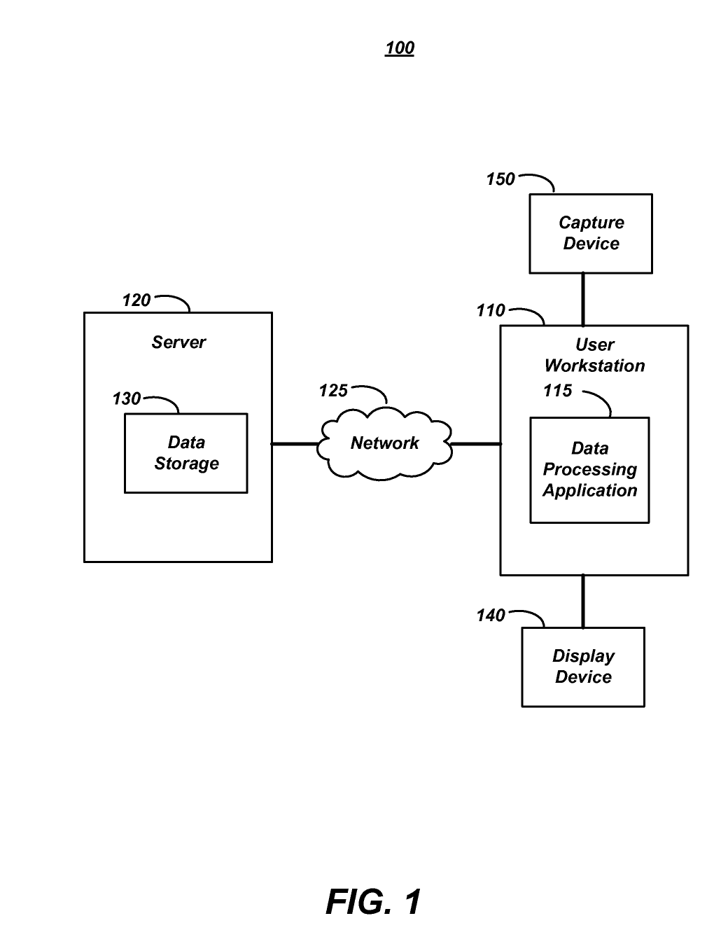

FIG. 1 is a block diagram of an operating environment 100 for providing conditional localization comprising a user workstation 110. User workstation 110 may comprise a data processing application 115 and may be operative to interact with a server 120 via a network 125. For example, user workstation 110 may be operative to access and/or interact with a collaboration application provided by server 120 (e.g., Microsoft® Sharepoint®) that may perform various operations in response to user commands such as downloading and/or uploading one or more files. Such files and/or other data may be stored in a data storage 130 that may be accessed by multiple users from different workstations. User workstation 110 may comprise, for example, an electronic communications device such as a computer, laptop, cellular and/or IP phone, tablet, game console and/or other device. User workstation may be coupled to a display device 140, such as a monitor and/or touchscreen. User workstation 110 may further be coupled to a capture device 150 that may be operative to record a user and capture spoken words, motions and/or gestures made by the user, such as with a camera and/or microphone. User device 135 may be further operative to capture other inputs from the user such as by a keyboard, touchscreen, stylus and/or mouse (not pictured). Consistent with embodiments of the invention, capture device 150 may comprise any speech and/or motion detection device capable of detecting the speech and/or actions of the user. For example, capture device 150 may comprise a Microsoft® Kinect® motion capture device comprising a plurality of cameras and a plurality of microphones.

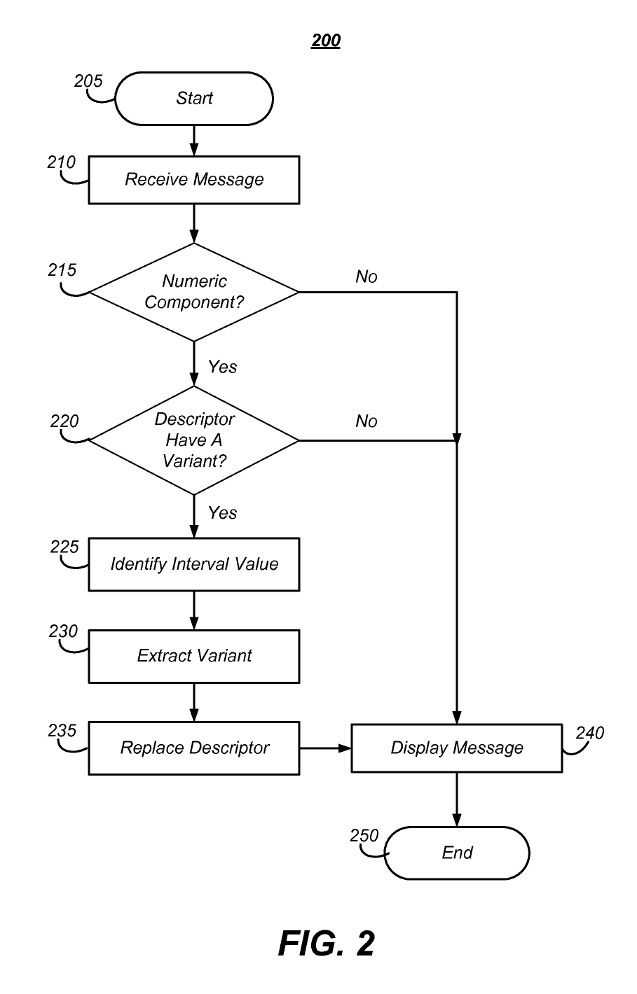

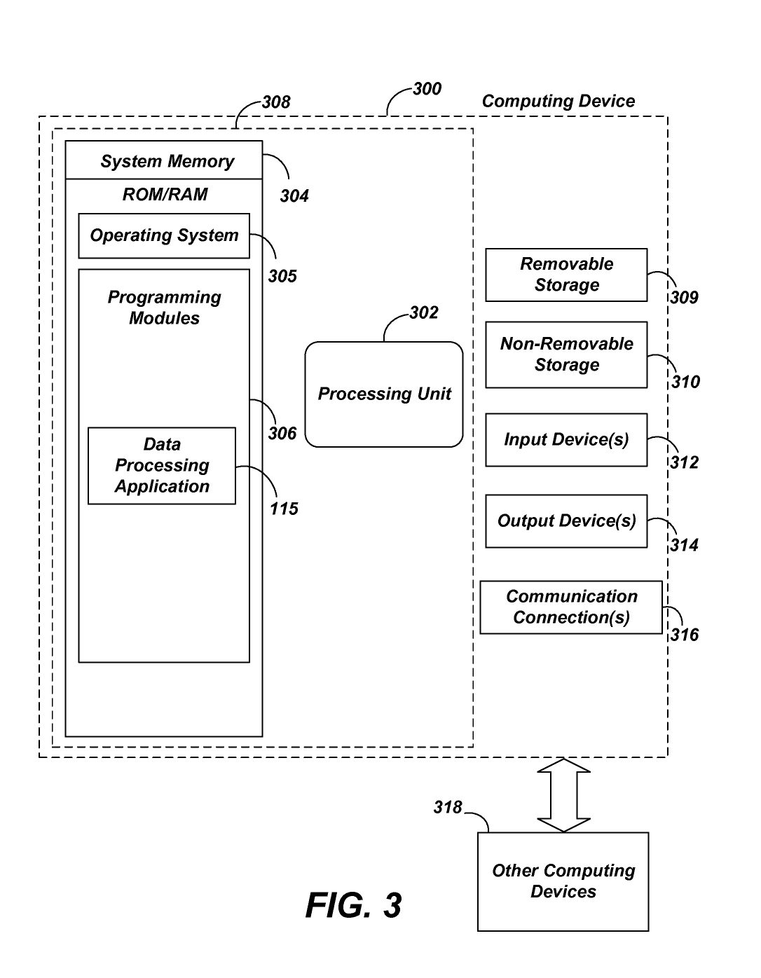

FIG. 2 is a flow chart setting forth the general stages involved in a method 200 consistent with an embodiment of the invention for providing conditional localization. Method 200 may be implemented using a computing device 300 as described in more detail below with respect to FIG. 3. Ways to implement the stages of method 200 will be described in greater detail below. Method 200 may begin at starting block 205 and proceed to stage 210 where computing device 300 may receive a message for display to a user interface. For example the user interface may be associated with data processing application 115. The application may comprise a plurality of configuration options, such as a local language setting.

Method 200 may then advance to stage 215 where computing device 300 may determine whether the message comprises a numeric component associated with a descriptor word. For example, the message to display may be a confirmation that N files were successfully uploaded where N comprises the numeric component.

Method 200 may then advance to stage 220 where computing device 300 may, in response to determining that the message comprises a numeric component, determine whether the descriptor word is associated at least one of a plurality of variant records associated with the local language setting. For example, an application may scan a file and/or database comprising a plurality of variant records for a record associated with the descriptor word, such as “file” in the example given above where the message comprises “N files were successfully uploaded.”

In response to determining that the descriptor word is associated with the variant record, method 200 may advance to stage 225 where computing device 300 may identify one of the plurality of interval values of the variant record encompassing the numeric component. Each of the plurality of interval values may be separated by a delimiting character. Additionally, each of the plurality of interval values may comprise at least one integer and may comprise a range. Each of the plurality of variant records may comprise a plurality of interval values each associated with one of a plurality of variant words. A variant record for “file” may, for example, associate 0 with “files”, 1 with “file”, and 2 or more with “files”.

Method 200 may then advance to stage 230 where computing device 300 may extract the variant word associated with the one of the plurality of interval values from the variant record. For example, where the value of N in “N files were successfully uploaded” is 1, the variant word may comprise “file”, but if the value of N is 4, the variant word may comprise “files.”

Method 200 may then advance to stage 235 where computing device 300 may replace the descriptor word in the message with the extracted variant word. For example, for the message “N files were successfully uploaded” where the value of N is 1, “files” may be replaced with “file.”

If no numeric component was found in stage 215, if no variant was found at stage 200, or after replacing the descriptor word at stage 235, method 200 may advance to stage 240 where computing device 300 may display the message on the user interface associated with the application. Method 200 may then end at stage 250.

An embodiment consistent with the invention may comprise a system for providing conditional localization. The system may comprise a memory storage and a processing unit coupled to the memory storage. The processing unit may be operative to prepare a message comprising a numeric component for display on a user interface. In response to determining that the numeric component is associated with the descriptor word, the processing unit may be operative to retrieve a localized variant of the descriptor word according to the numeric component.

Another embodiment consistent with the invention may comprise a system for providing conditional localization. The system may comprise a memory storage and a processing unit coupled to the memory storage. The processing unit may be operative to receive a message for display to a user interface and determine whether the message comprises a numeric component. If so, the processing unit may be operative to determine whether a descriptor word associated with the numeric component comprises a variant record and, if so, extract a variant word from the variant record according to the numeric component, and replace the descriptor word in the message with the variant word, and display the message on the user interface.

Yet another embodiment consistent with the invention may comprise a system for providing conditional localization. The system may comprise a memory storage and a processing unit coupled to the memory storage. The processing unit may be operative to receive a message for display to a user interface and determine whether the message comprises a numeric component associated with a descriptor word. If so, the processing unit may be operative to determine whether the descriptor word is associated at least one of a plurality of variant records associated with the local language setting and, if so, identify one of a plurality of interval values of the variant record encompassing the numeric component, extract the variant word associated with the one of the plurality of interval values from the variant record, replace the descriptor word in the message with the extracted variant word, and display the message on the user interface associated with the application.

FIG. 4 is a block diagram of a system including computing device 400. Consistent with an embodiment of the invention, the aforementioned memory storage and processing unit may be implemented in a computing device, such as computing device 400 of FIG. 4. Any suitable combination of hardware, software, or firmware may be used to implement the memory storage and processing unit. For example, the memory storage and processing unit may be implemented with computing device 400 or any of other computing devices 418, in combination with computing device 400. The aforementioned system, device, and processors are examples and other systems, devices, and processors may comprise the aforementioned memory storage and processing unit, consistent with embodiments of the invention. Furthermore, computing device 400 may comprise operating environment 400 as described above. Methods described in this specification may operate in other environments and are not limited to computing device 400.

With reference to FIG. 4, a system consistent with an embodiment of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include data processing application 115. Operating system 405, for example, may be suitable for controlling computing device 400's operation. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computing device 400 may also contain a communication connection 416 that may allow device 400 to communicate with other computing devices 418, such as over a network in a distributed computing environment, for example, an intranet or the Internet. Communication connection 416 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As stated above, a number of program modules and data files may be stored in system memory 404, including operating system 405. While executing on processing unit 402, programming modules 406 may perform processes and/or methods as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the invention may be practiced via a system-on-a-chip (SOC) where each and/or many of the components illustrated above may be integrated onto a single integrated circuit. Such an SOC device may include one or more processing units, graphics units, communications units, system virtualization units and various application functionalities, all of which may be integrated (or “burned”) onto the chip substrate as a single integrated circuit. When operating via an SOC, the functionality, described herein, with respect to training and/or interacting with any component of operating environment 100 may operate via application-specific logic integrated with other components of the computing device/system on the single integrated circuit (chip).

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicants. The Applicants retain and reserve all rights in the code included herein, and grant permission to reproduce the material only in connection with reproduction of the granted patent and for no other purpose.

While certain embodiments of the invention have been described, other embodiments may exist. While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

We claim:

1. A method for providing conditional localization, the method comprising:
preparing a message to display on a user interface, wherein the message comprises a numeric component;
determining whether the numeric component is associated with a descriptor word;
in response to determining that the numeric component is associated with the descriptor word, retrieving a localized variant of the descriptor word according to the numeric component.

2. The method of claim 1, wherein retrieving the localized variant comprises comparing the numeric component to a plurality of interval values associated with the descriptor word.

3. The method of claim 2, wherein at least one of the plurality of interval values comprises a range.

4. The method of claim 2, wherein at least one of the plurality of interval values comprises a negative number.

5. The method of claim 2, wherein at least one of the plurality of interval values comprises an empty string.

6. The method of claim 5, wherein the empty string evaluates to an end range interval value of positive infinity.

7. The method of claim 2, further comprising storing the plurality of interval values and associated localized variants in a resource file.

8. The method of claim 2, further comprising storing the plurality of interval values and associated localized variants in a pair of resource files.

9. The method of claim 2, further comprising storing the plurality of interval values and associated localized variants in XML format.

10. The method of claim 1, wherein the localized variant of the descriptor word is language specific.

11. A system for providing conditional localization, the system comprising:
a memory storage; and
a processing unit coupled to the memory storage, wherein the processing unit is operable to:
receive a message for display to a user interface,
determine whether the message comprises a numeric component,
in response to determining that the message comprises a numeric component, determine whether a descriptor word associated with the numeric component comprises a variant record,
in response to determining that the descriptor word associated with the numeric component comprises a variant record:
extract a variant word from the variant record according to the numeric component; and
replace the descriptor word in the message with the variant word, and display the message on the user interface.

12. The system of claim 11, wherein the variant record comprises a plurality of intervals.

13. The system of claim 12, wherein each of the plurality of intervals are associated with a corresponding variant word.

14. The system of claim 13, wherein being operative to extract the variant word from the variant record according to the numeric component comprises the processing unit being operative to extract the corresponding variant word associated with a one of the plurality of intervals encompassing the numeric component.

15. The system of claim 11, further comprising a database operative to store a list of a plurality of variant records and a plurality of intervals each associated with a one of the plurality of variant records.

16. The system of claim 11, wherein the processing unit is further operative to retrieve a list of a plurality of variant records and a plurality of intervals each associated with a one of the plurality of variant records from a remote storage location via a network.

17. The system of claim 16, wherein the retrieved list of a plurality of variant records and the associated plurality of intervals are retrieved as at least one delimited text file.

18. The system of claim 11, wherein the variant record is associated with a language setting.

19. The system of claim 11, further comprising a plurality of variant record sets each associated with a supported language configuration for the system.

20. A computer-readable medium which stores a set of instructions which when executed performs a method for providing conditional localization, the method executed by the set of instructions comprising:
receiving a message for display to a user interface, wherein the user interface is associated with an application comprising a local language setting;
determining whether the message comprises a numeric component associated with a descriptor word;
in response to determining that the message comprises a numeric component, determining whether the descriptor word is associated at least one of a plurality of variant records associated with the local language setting, wherein each of the plurality of variant records comprises a plurality of interval values each associated with one of a plurality of variant words;
in response to determining that the descriptor word is associated with the at least one a variant record:
identifying a one of the plurality of interval values of the variant record encompassing the numeric component, wherein each of the plurality of interval values are separated by a delimiting character and wherein each of the plurality of interval values comprise at least one integer,
extracting the variant word associated with the one of the plurality of interval values from the variant record, wherein each of the plurality of variant words are separated by the delimiting character, and
replacing the descriptor word in the message with the extracted variant word; and
displaying the message on the user interface associated with the application.
